(19) United States
(12) Patent Application Publication
(10) Pub. No.: US 2026/0338169 A1
(43) Pub. Date: Oct. 29, 2026

(54) ACTUATOR HAVING SHAPE MEMORY ALLOY CONTRACTION ELEMENTS

(71) Applicant: Deutsches Zentrum für Luft- und Raumfahrt e.V., Bonn (DE)

(72) Inventor: Siebo Reershemius, Vechta (DE)

(21) Appl. No.: 19/703,400

(22) Filed: Jun. 10, 2026

Related U.S. Application Data
(63) Continuation-in-part of application No. PCT/EP2024/085216, filed on Dec. 9, 2024.

(30) Foreign Application Priority Data
Dec. 11, 2023 (DE) 10 2023 134 550.8

(51) Int. Cl. F03G 7/06

(52) U.S. Cl. CPC F03G 7/0614; F03G 7/0636

(57) ABSTRACT

An actuator comprises two connection pieces spaced apart from one another in the direction of an actuator main axis, a preload arrangement applying a preload force to the two connection pieces, the preload force pressing the two connection pieces apart in the direction of the actuator main axis, the preload arrangement comprising a cylindrical-shell-section-shaped friction spring, and bolt-shaped contraction elements made of a shape memory alloy and supported at the two connection pieces. The bolt-shaped contraction elements extend over free lengths between the two connection pieces. Between the two connection pieces, the bolt-shaped contraction elements extend within the cylindrical-shell-section-shaped friction spring and the bolt-shaped contraction elements are wrapped with at least one of heating wires, heating strips or heating foils. Upon increasing their temperature with the at least one of heating wires, heating strips or heating foils, the bolt-shaped contraction elements shorten their free lengths between the two connection pieces.

### CROSS REFERENCE TO RELATED APPLICATIONS

This application is a continuation in part of International Application PCT/EP2024/085216 with an international filing date of Dec. 9, 2024 entitled “Actuator having elements made of shape memory alloy” and claiming priority to co-pending German Patent Application 10 2023 134 550.8 entitled “Aktor mit Elementen aus Formgedächtnislegierung” and filed on Dec. 11, 2023.

### FIELD OF THE INVENTION

The invention relates to actuators having two connection pieces spaced apart from one another in the direction of an actuator main axis, a preload arrangement which applies a preload force pressing the connection pieces apart in the direction of the actuator main axis, and contraction elements extending along the actuator main axis between the connection pieces, the contraction elements being made of a shape memory alloy and being controllable so as to shorten their lengths between the connection pieces.

Furthermore, the invention relates to a device for holding and releasing a bolt, comprising a socket for receiving a section of the bolt and comprising such an actuator, the actuator being arranged such that the bolt is released or releasable from the socket, when the contraction elements of the actuator are controlled so as to shorten their lengths between the connection pieces.

### Stand Der Technik

An actuator known from German patent DE 10 2021 103 203 B3 comprises two end pieces elastically supported against one another in the direction of an actuator main axis by means of a compression spring, and a wire composed of a shape memory alloy tensioned along the actuator main axis between the end pieces, the wire being controllable so as to undergo a change in length. The wire comprises at least six contiguous length sections which are each tensioned adjacent to one another along the actuator main axis between the end pieces, whereby the arrangement of the end pieces is stabilized against relative tilting. The wire may comprise at least 12 or at least 24 or even at least 36 contiguous length sections, each of which is tensioned along the actuator main axis between the end pieces. In this case, the arrangement of the length sections tensioned between the end pieces may be rotationally symmetrical with respect to the actuator main axis to the same multiplicity as the number of length sections tensioned between the end pieces. Specifically, the length sections are tensioned between points of the end pieces which are arranged along a circular-arc-shaped circumference of the respective end piece extending at a spacing around the actuator main axis. In this case, the wire may be guided between its length sections around hooks arranged on the circumferences of both end pieces. Equal angles of the length sections relative to a reference plane to which the actuator main axis is a surface normal may be 90°, and the length sections tensioned between the end pieces may be arranged at spacings from the actuator main axis which lie within a range from one times to three times their length between the end pieces. The wire is controlled so as to undergo a thermally induced shortening by applying an electrical voltage between its ends. The compression spring is dimensioned such that it lengthens the wire again as soon as the wire cools again below the transition temperature of its shape memory alloy. The known actuator is intended in particular to apply a force to a clamping sleeve into a receptacle in a base body, wherein the force with which the clamping sleeve is applied into the receptacle is withdrawn by controlling the wire so as to shorten. In this way, a bolt clamped in the clamping sleeve is released.

German patent application publication DE 10 2019 100 694 A1 discloses a shape memory actuator arrangement comprising a wire-shaped shape memory element, a first deflection body and a second deflection body. The deflection bodies are arranged spaced apart from one another. The wire-shaped shape memory element is wound multiple times around the first deflection body and the second deflection body and forms an actuating member arrangement therebetween. At least one wire holder region on the respective deflection body and the sections of the wire-shaped shape memory element contacting the wire holder region are embedded in a potting compound. The potting compound is electrically insulating and thereby electrically insulates the individual windings of the wire-shaped shape memory element from one another. Potting cups may be associated with both deflection bodies, wherein the potting compound mechanically couples the respective deflection body to the respective potting cup for transmission of actuator forces. In this case, the potting compound completely encloses the respective deflection body. The potting cup comprises a fastening element for deriving the actuator forces. Groove-shaped wire receptacles are formed in the wire holder region of the respective deflection body. A partial section of the actuating member arrangement between the first deflection body and the second deflection body may be embedded in an actuating member potting element which is materially bonded to the potting compound. The material selected for the actuating member potting element is electrically insulating and exhibits sufficient elasticity so that the actuator function is not substantially influenced. In all embodiments of the known shape memory actuator arrangement, a width of the actuating member arrangement embedded in the actuating member potting element between the deflection bodies is significantly smaller than 20% of the spacing between the deflection bodies. In other words, the known shape memory actuator arrangement is narrow and elongated.

German patent application publication DE 195 297 12 A1 discloses a shape memory actuator for an actuating mechanism, for example on spacecraft, comprising a heatable actuating member made of a shape memory alloy. The actuating member consists of at least one thin wire arranged in multiple windings. The windings of the wire are electrically insulated from one another and can be heated by a current flowing therethrough. Specifically, the windings of the wire are electrically insulated from one another in that they are kept spaced apart by spacers. In this case, the windings of the wire are guided around elements movable relative to one another and are positively fastened to these elements.

German patent application publication DE 197 303 83 A1 discloses a method for training elements made of shape memory alloy. In order to carry out the method, an actuator is provided with the elements made of the shape memory alloy, and the actuator is trained in conformity with the application as a substantially self-contained unit provided with the untrained elements. A device for carrying out this known method is an actuator having elements made of shape memory alloy. The elements made of shape memory alloy are wires. Windings of the wires positively surround structural elements. In addition to the structural elements to be actuated, removable auxiliary elements are provided. The auxiliary elements comprise a preload spring in conjunction with a guide tube, which is arranged between deflection bodies and has a low stiffness and serves to maintain the shape of the windings of the wire made of shape memory alloy. Helical grooves are provided on the deflection bodies in such a way that a parallel tension within the windings made of shape memory alloy is ensured. In a schematic illustration of the deflection bodies having the helical grooves of a predetermined pitch, the length ratios of which do not correspond to the further figures and statements of DE 197 303 83 A1, the windings made of shape memory alloy are distributed over a width extending transversely to their longitudinal extensions, said width being approximately 60% as large as the spacing of the support of the windings on the deflection bodies.

European patent application publication EP 0 137 502 A2 discloses an actuator having a plurality of elements made of shape memory material. The elements are arranged parallel to one another between a stationary connection piece and a movable connection piece. The elements may be wires, helical springs or strips of rectangular cross section. The stationary connection piece and the movable connection piece are elastically supported against one another via a piston-and-cylinder arrangement having a helical spring located in the cylinder.

United States patent application publication US 2018/0 266 400 A1 discloses an actuator having a tubular braid composed of wires made of shape memory alloy electrically insulated from one another. The tubular braid extends between two connection pieces.

German patent application publication DE 10 2017 007 596 A1 discloses a shape memory actuator arrangement comprising a first deflection body having a connection to a first fastening element, a second deflection body spaced apart from the first deflection body and having a connection to a second fastening element, and a one-piece shape memory element connected at its ends to the first deflection body and/or the second deflection body. A multiple winding of the one-piece shape memory element extends around the first deflection body and the second deflection body.

European patent EP 2 028 309 B1 discloses a strip having a fabric composed of threads made of a shape memory alloy.

There still is a need of actuators and a device for holding and releasing a bolt having such an actuator, which are simpler to manufacture and adaptable to the respective application.

### SUMMARY OF THE INVENTION

The present invention relates to an actuator comprising a virtual actuator main axis, two connection pieces spaced apart from one another in the direction of the actuator main axis, a preload arrangement applying a preload force to the two connection pieces, the preload force pressing the two connection pieces apart in the direction of the actuator main axis, the preload arrangement comprising a friction spring, the friction spring comprising inner ring elements and outer ring elements engaging into one another and supported against one another via complementary conical surfaces of the inner ring elements and the outer ring elements, and bolt-shaped contraction elements made of a shape memory alloy and supported at the two connection pieces. The bolt-shaped contraction elements extend over free lengths between the two connection pieces. Between the two connection pieces, the bolt-shaped contraction elements extend through the inner rings and the outer rings of the friction spring, and the bolt-shaped contraction elements are wrapped with at least one of heating wires, heating strips or heating foils. The bolt-shaped contraction elements, upon increasing their temperature with the at least one of heating wires, heating strips or heating foils, shorten their free lengths between the two connection pieces.

Further, the present invention relates to an actuator comprising two connection pieces spaced apart from one another in the direction of an actuator main axis, a preload arrangement applying a preload force to the two connection pieces, the preload force pressing the two connection pieces apart in the direction of the actuator main axis, the preload arrangement comprising a cylindrical-shell-section-shaped friction spring, and bolt-shaped contraction elements made of a shape memory alloy and supported at the two connection pieces. The bolt-shaped contraction elements extend over free lengths between the two connection pieces, Between the two connection pieces, the bolt-shaped contraction elements extend within the cylindrical-shell-section-shaped friction spring, and the bolt-shaped contraction elements are wrapped with at least one of heating wires, heating strips or heating foils. The bolt-shaped contraction elements, upon increasing their temperature with the at least one of heating wires, heating strips or heating foils, shorten their free lengths between the two connection pieces.

Even further, the present invention relates to a device for holding and releasing a bolt. The device comprises a socket for receiving a section of the bolt, and an actuator comprising a virtual actuator main axis, two connection pieces spaced apart from one another in the direction of the actuator main axis, a preload arrangement applying a preload force to the two connection pieces, the preload force pressing the two connection pieces apart in the direction of the actuator main axis, the preload arrangement comprising a friction spring, the friction spring comprising inner ring elements and outer ring elements engaging into one another and supported against one another via complementary conical surfaces of the inner ring elements and the outer ring elements, and bolt-shaped contraction elements made of a shape memory alloy and supported at the two connection pieces. The bolt-shaped contraction elements extend over free lengths between the two connection pieces. Between the two connection pieces, the bolt-shaped contraction elements extend through the inner rings and the outer rings of the friction spring, and the bolt-shaped contraction elements are wrapped with at least one of heating wires, heating strips or heating foils. The bolt-shaped contraction elements, upon increasing their temperature with the at least one of heating wires, heating strips or heating foils, shorten their free lengths between the two connection pieces. The actuator is arranged such that the bolt is secured in the socket by the preload force applied to the two connection pieces and released of releasable from the socket, when the temperature of the bolt-shaped contraction elements is increased with the at least one of heating wires, heating strips or heating foils so as to shorten their free lengths between the two connection pieces.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a perspective view of an embodiment of an actuator according to the present disclosure.

FIG. 2 is a perspective view of another embodiment of an actuator according to the present disclosure.

FIG. 3 is a view substantially corresponding to FIG. 2, in which some windings of a wire made of shape memory alloy are omitted in order to show an internal structure of a contraction element of the actuator according to FIG. 2.

FIG. 4 is a perspective view of the actuator according to FIGS. 2 and 3, in which one connection piece of the actuator is omitted in order to show an adjustment device of the actuator.

FIG. 5 is a perspective view of the actuator according to FIGS. 2 to 4 from a viewing direction similar to that in FIG. 4, but showing both connection pieces thereof.

FIG. 6 is an exploded view of the actuator according to FIGS. 2 to 5 with the same viewing direction as that of FIGS. 2 and 3.

FIG. 7 is a perspective view of a further embodiment of an actuator according to the present disclosure.

FIG. 8 is a view substantially corresponding to FIG. 7, in which some windings of a wire and of a tension wire made of shape memory alloy are omitted in order to show an internal structure of a contraction element and of a preload arrangement of the actuator according to FIG. 7.

FIG. 9 is a view substantially corresponding to FIGS. 7 and 8, in which all windings of the wire and of the tension wire made of shape memory alloy are omitted in order to show the internal structure of the contraction elements and of the preload arrangement of the actuator according to FIGS. 7 and 8.

FIG. 10 is an exploded view of the actuator according to FIGS. 7 to 9 with the same viewing direction as that of FIGS. 7 to 9.

FIG. 11 is an axial sectional view of an embodiment of another actuator according to the present disclosure.

FIG. 12 is a perspective external view of the embodiment of the other actuator according to FIG. 11.

FIG. 13 is an axial sectional view of a friction spring of the embodiment of the other actuator according to FIGS. 11 and 12, and

FIG. 14 is a perspective external view of a device for holding and releasing a bolt according to the present disclosure comprising the other actuator according to FIGS. 11 to 13.

### DETAILED DESCRIPTION

In an actuator according to an aspect of the present disclosure having two connection pieces spaced apart from one another in the direction of an actuator main axis, a preload arrangement which applies a preload force pressing the connection pieces apart in the direction of the actuator main axis, and two contraction elements extending along the actuator main axis between the connection pieces, the contraction elements being made of a shape memory alloy and being controllable so as to shorten their free lengths between the connection pieces, the contraction elements extending between the connection pieces are arranged axisymmetrically and/or rotationally symmetrically relative to the actuator main axis. Relative to a reference plane to which the actuator main axis is a surface normal, the contraction elements extend at equal angles. Parallel to the reference plane, the connection pieces have rectangular outlines. The contraction elements are strip-shaped, each extending parallel to a main extension plane and having widths extending parallel to the reference plane. The two contraction elements are fixed over their widths to the connection pieces at respectively two mutually parallel sides of the outlines of the connection pieces. The widths of the contraction elements amount to at least 50% of side lengths of the two mutually parallel sides of the outlines of the connection pieces.

The relatively wide contraction elements each extend along a rectilinear side edge or planar side surface of each of the two connection pieces and are then fixed to these side edges or side surfaces of the two connection pieces. In this way, the contraction elements are not only easy to mount on the connection pieces, but can also be demounted again in order, for example, to replace the preload arrangement or at least parts of the preload arrangement or the contraction elements themselves. Such a replacement may be expedient in order to adapt the actuator to its respective application. In this case, the spacing of the connection pieces and thus the height of the actuator can be varied via the lengths of the contraction elements between the connection pieces.

The widths of the contraction elements may amount to at least 60% or at least 75%, and often to at least 90% of the side lengths of the two mutually parallel sides of the outlines of the connection pieces. In one embodiment, the widths of the contraction elements are approximately exactly as large as their free lengths between the connection pieces. However, the free lengths of the contraction elements may even be significantly greater than their widths.

Radial spacings of the contraction elements from the actuator main axis are generally not less than 20%; they may be not less than 30% and, in many cases, not less than 70% of their widths. On the other hand, the radial spacings of the contraction elements from the main axis are generally not greater than 100%; they may be not greater than 80% and in many cases not greater than 60% of their widths. In an embodiment, the radial spacings of the contraction elements from the actuator main axis amount to approximately half of their widths.

The two contraction elements may be arranged on the side edges or side surfaces of connection pieces having square outlines. If the sides of the outlines of the connection pieces have different lengths, then the contraction elements may be fixed to the sides having the greater side length, i.e. where more space is available. In the case of the two contraction elements lying opposite one another across the actuator main axis, a preload arrangement arranged between the connection pieces remains accessible across their spacing. For example, in the case of a width of the contraction elements corresponding to their free length between the connection pieces, this is achieved without instability of the actuator with regard to mutual tilting of the connection pieces being to be feared.

The equal angles at which the contraction elements extend relative to the reference plane to which the actuator main axis is a surface normal may be right angles, that is to say they may amount to 90°.

Each contraction element may be subdivided in the direction of its width into, in particular, two partial contraction elements, the partial widths of which add up to the width of the respective contraction element. Such a subdivision of the contraction elements may be useful in order to fix the contraction elements to the connection pieces over their entire widths. For example, cross members for the contraction elements may be supported between the partial contraction elements on a base structure of the respective connection piece.

Each contraction element may comprise a strip or a plate made of the shape memory alloy extending between the connection pieces and clamped to the connection pieces, the strip width thereof amounting to at least 90% or even at least 95% of the width of the respective contraction element. Such a strip and in particular such a plate made of the shape memory alloy exhibits high dimensional rigidity in the decisive directions. In this way, the two connection pieces are guided relative to one another with high rigidity by the contraction elements fixed thereto.

As an alternative or in addition to the strip made of the shape memory alloy, each contraction element may comprise at least eight length sections of a wire made of the shape memory alloy, which extend between the connection pieces and are distributed over at least 90% or even at least 95% of the width of the contraction element. Such a wire made of the shape memory alloy, unlike a strip or a plate made of shape memory alloy, is commercially available in trained form in various thicknesses. The length sections of the wire of each contraction element may extend in its main extension plane or parallel to its main extension plane. In an embodiment, each of the contraction elements comprises at least 16 or even at least 32 of the length sections of the wire made of the shape memory alloy. The number of length sections of each contraction element may also be much greater and may, for example, reach or even exceed one hundred.

A quarter, a third or half of the length sections of each contraction element may then respectively be contiguous, so that each contraction element comprises four, three or two non-contiguous wires made of the shape memory alloy, which may then be connected in parallel during energization thereof for resistive heating to above the transition temperature of the shape memory alloy.

The respective contiguous wires made of the shape memory alloy may be guided around end-side deflection bodies at the ends of the respective strip-shaped contraction element. These deflection bodies then extend over the width of the respective strip-shaped contraction element; and, according to an aspect of the present disclosure, they are each formed, at least at their outer circumference, from a thermally and electrically insulating material in order to thermally and electrically insulate the individual windings of the wire made of the shape memory alloy from the connection pieces and, in particular, electrically from one another.

Each contraction element, in particular each contraction element comprising length sections of a wire made of the shape memory alloy, may comprise a plastics matrix in which the length sections of the wire and optionally reinforcing fibers are embedded. The reinforcing fibers may be not electrically conductive. By means of the plastics matrix, in particular when reinforcing fibers are embedded therein, dimensional stiffening of the contraction elements similar to that of a strip made of the shape memory alloy is achieved, although the contraction elements contain commercially available and cost-effective wire made of the shape memory alloy. The reinforcing fibers may in particular be aligned in mutually crossing directions having a diagonal course relative to the lengths of the contraction elements between the connection pieces.

As an alternative or additionally to direct electrical, i.e. resistive heating of strips or wires made of the shape memory alloy, indirect heating may also be realized according to an aspect of the present disclosure in that each contraction element comprises at least one heating element arranged adjacent to the shape memory alloy. This heating element may likewise be an electrical heating element which is controllable so as to cause a temperature increase by applying an electrical voltage between its ends.

With heating elements separated from the shape memory alloy and from strips, plates or wires made thereof. the cross section of the strips, plates or wires can be increased as required according to the forces to be applied by the contraction elements, without this having an effect on the direct resistive heating of the strips, plates or wires. According to an aspect of the present disclosure, the relative arrangement of the heating elements with respect to the strips, plates or wires made of the shape memory alloy can easily be fixed in that the heating elements and the strips or wires are jointly embedded in the plastics matrix. In this case, thermal insulation caused by the plastics matrix may be utilized. The thermal insulation delays dissipation of the thermal energy introduced by means of the heating elements and thereby accelerates heating of the shape memory alloy to above its transition temperature.

According to an aspect of the present disclosure, the shape memory alloy is one which reduces the length of the contraction elements between the connection pieces upon an increase in temperature above its transition temperature. In this case, the preload force of the preload arrangement may be dimensioned or preloaded such that it lengthens the contraction elements again as soon as the shape memory alloy cools again below its transition temperature. However, the shape memory alloy may also be a two-way shape memory alloy which automatically lengthens upon its temperature falling below its transition temperature.

According to an aspect of the present disclosure, a compression spring of the preload arrangement is supported on one of the connection pieces via an abutment, the relative position of which with respect to the one connection piece is adjustable in the direction of the actuator main axis. By means of a linear displacement of the abutment relative to the one connection piece in the direction of the actuator main axis, a preload of the compression spring can be varied and, for example, increased to such an extent that the compression spring lengthens the contraction elements again as soon as the shape memory alloy cools again below its transition temperature.

The adjustability of the relative position of the abutment with respect to the one connection piece may specifically be realized by means of adjusting screws aligned along the actuator main axis. In an embodiment, three adjusting screws are provided in a rotationally symmetrical arrangement around the actuator main axis. By means of these three adjusting screws, the abutment can be linearly displaced relative to the connection piece without requiring an additional linear guide for the abutment relative to the connection piece. Rather, if all three adjusting screws are of identical configuration, it is sufficient to rotate all three adjusting screws by the same angle in the same direction of rotation. By differentially rotating the adjusting screws, however, angular adjustment of the abutment relative to the connection piece can also be carried out, for example in order to compensate for an end face of the compression spring not extending exactly normal to the actuator main axis. Furthermore, the adjusting screws may also be loosened to such an extent that the compression spring can be replaced without requiring further disassembly of the actuator according to this aspect of the present disclosure, if free access to the compression spring is possible through the space between the contraction elements.

In a further embodiment of the actuator according to the present disclosure, the preload arrangement comprises tension wires extending along the actuator main axis between two further connection pieces. The two further connection pieces are arranged on two cantilevers which each extend away from one of the connection pieces along the actuator main axis and thereby cross one another along the actuator main axis, so that an order of the further connection pieces along the actuator main axis is interchanged relative to the connection pieces rigidly connected thereto via the cantilevers. In this case, the tension wires may be made of a superelastic shape memory alloy. The fact that the shape memory alloy of the tension wires is superelastic means that the tension wires are in a superelastic state during the intended use of the actuator and during control of its contraction elements for shortening in length, which elongates the tension wires. For this purpose, the shape memory alloy of the tension wires is at a temperature slightly above its transition temperature, and during elongation of the tension wires, increasing portions of the shape memory alloy are transformed from its high-temperature phase into its low-temperature phase, in which the tension wires are longer.

In the embodiment of the actuator described last, the increase in spacing of the further connection pieces in the direction of the actuator main axis resulting from the shortening in length of the contraction elements may also be tapped and utilized. Furthermore, means may be provided for controlling the tension wires so as to shorten in length by increasing the temperature of their shape memory alloy above its transition temperature. In particular, the tension wires may be controlled so as to shorten in length in order to elongate the contraction elements, which were previously controlled so as to shorten in length by temperature increase and have thereafter already cooled, back to their initial length.

Typically, the preload arrangement comprises a compression spring located between the connection pieces under compressive preload. The compression spring may comprise, for example, a helical compression spring, a disc spring and/or a friction spring. In this case, a preload arrangement having a friction spring with interengaging ring elements supported against one another via conical surfaces, see www.reibungsfeder.de, is useful in an actuator and in a device for holding and releasing a bolt having such an actuator according to the present disclosure. By means of a friction spring, a high preload force can be applied, wherein the friction between its ring elements provides strong damping of relative movements of the connection pieces and thereby prevents undesired accelerations of coupled objects, specifically in both directions, i.e. both during contraction and during renewed elongation of the contraction elements. Further, the elastic properties of such a friction spring display a rather small temperature dependency. This particularly applies if t such a friction spring is compared to a preload arrangement comprising tension wires made of a superelastic shape memory alloy.

A cylindrical-shell-section-shaped friction spring, but also any other cylindrical-shell-section-shaped compression spring, can be combined with bolt-shaped contraction elements made of a shape memory alloy, which are wrapped with heating wires, heating strips or heating foils in order to control them so as to shorten their free lengths between the connection pieces, and which are arranged inside the respective cylindrical-shell-shaped compression spring. According to German utility model DE 20 2024 105 238 U1, such bolt-shaped contraction elements are used together with a preload arrangement comprising bolt-shaped spring elements. In the case of contraction elements arranged inside the cylindrical-shell-shaped compression spring, the connection pieces may be formed in the shape of circular discs, wherein their diameter need only be slightly greater, i.e. for example at most 10% greater, than an outer diameter of the compression spring in order to support the latter securely. This results in a very compact construction in which the contraction elements with the heating wires, heating strips or heating foils extend protected within the cylindrical-shell-section-shaped compression spring between the connection pieces.

In a device according to the present disclosure for holding and releasing a bolt, comprising a socket or a clamping sleeve for receiving a section of the bolt and an actuator according to the present disclosure, the actuator is arranged such that the bolt is secured in the socket or clamping sleeve by the preload force applied to the two connection pieces and released or releasable from the socket or from the clamping sleeve, when the contraction elements of the actuator are controlled so as to shorten their lengths between the connection pieces. For example, the socket or the clamping sleeve may be relieved of a force applied by the compression spring, when the contraction elements shorten their lengths.

An actuator according to the present disclosure may also be used for directly holding and releasing structural elements, in that, for example, one of its connection pieces bears against one side of a structural element or a plurality of structural elements stacked on top of one another, while on the other side of this structural element or of the stack of structural elements an anchor element bears, which is supported on the other connection piece by means of a tension bolt extending through the structural element or the stack of structural elements, the one connection piece and the compression spring as far as the other connection piece. When the contraction elements are shortened, the anchor element has a maximum spacing from the one connection piece at which the structural element or the stack of structural elements can be arranged between the one connection piece and the anchor element. When the shape memory alloy then cools and the contraction elements lengthen again, the structural element or the stack of structural elements is tensioned between the one connection piece and the anchor element. This tension can be selectively released by controlling the contraction elements so as to shorten their lengths between the connection pieces.

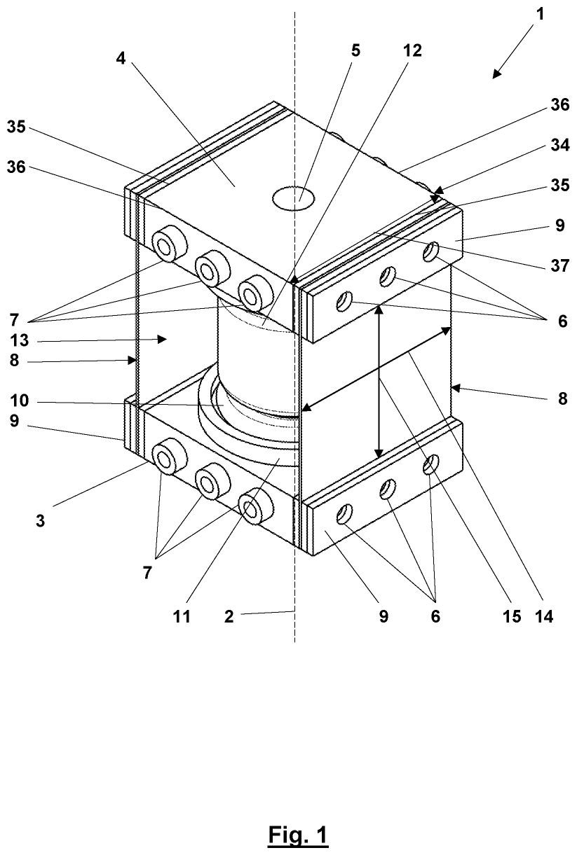

Now referring in greater detail to the drawings, the actuator 1 illustrated in FIG. 1 comprises two connection pieces 3 and 4 spaced apart from one another in the direction of an actuator main axis 2. The connection pieces 3 and 4 are dimensionally rigid solid plates having square outlines 34 bounded by sides 35 and 36 which are pairwise parallel to one another, a central opening 5 on the actuator main axis 2, and three threaded bores 6 in each of their four side surfaces for receiving fastening screws 7. Running along and here also parallel to the actuator main axis 2, two strip-shaped contraction elements 8 extend between the connection pieces 3 and 4. The strip-shaped contraction elements 8 are fixed over their entire widths to mutually opposite side surfaces of the connection pieces 3 and 4. For this purpose, fastening screws 7 engage with their threaded shanks through holding elements 9 and the contraction elements 8 into the threaded bores 6 in the respective side surface, which is not illustrated in FIG. 1, and are supported with their screw heads on the holding elements 9. The contraction elements 8 are made of a shape memory alloy and are controllable so as to shorten their lengths between the connection pieces 3 and 4 by heating the shape memory alloy to above its transition temperature. In the opposite direction along the actuator main axis 2, the connection pieces 3 and 4 are pressed apart by a compression spring 10 having an engagement protection sleeve of a preload arrangement 26. The compression spring 10 is supported on the connection piece 3 via a support plate 11. On the connection piece 4, the compression spring 10 is supported via a further support plate 12, wherein it is guided in a guide sleeve 13 fastened to this support plate 12. The compression spring 10 is dimensioned and preloaded between the connection pieces 3 and 4 such that it lengthens the contraction elements 8 again when the shape memory alloy thereof has cooled again below its transition temperature. Alternatively or additionally, the shape memory alloy is a two-way shape memory alloy, so that the contraction elements 8 automatically regain their original length when the temperature falls below the transition temperature. The strip-shaped contraction elements 8 each extend in or parallel to a main extension plane, wherein a width 14 of the contraction elements 8 in a virtual reference plane to which the actuator main axis 2 is a surface normal is here not only exactly as large as side lengths 37 of the sides 35 of the outlines 34 of the connection pieces 3, 4, but is also approximately exactly as large as a free length 15 of the contraction elements between the connection pieces 3 and 4. As a result, a dimensional rigidity of the contraction elements 8 is obtained which suppresses not only relative tilting of the connection pieces 3 and 4, but also relative displacements of the connection pieces 3 and 4 transversely to the actuator main axis 2, at least in the direction of the width 14.

The contraction elements 8 may each comprise a layered structure of one or more strips or one or more plates made of the shape memory alloy and one or more planar heating elements, which are adhesively bonded to one another and/or jointly embedded in a plastics matrix. The plastics matrix not only holds the layered structure together, but also thermally insulates it outwardly, so that heat introduced by the heating element is largely utilized for increasing the temperature of the strips or plates made of the shape memory alloy in order to exceed their transition temperature. Alternatively or additionally, wires made of the shape memory alloy extending along the actuator main axis 2 may also be embedded together with one or more heating elements in such a plastics matrix. Furthermore, the plastics matrix may be reinforced by embedded reinforcing fibers, which may be not electrically conductive reinforcing fibers. These reinforcing fibers may be aligned diagonally in a crossed manner relative to the width 14 and the free length 15.

A tension element not illustrated in FIG. 1 may extend from one of the connection pieces 3 and 4 through the adjacent support plate 11 or 12 and the compression spring 10 as well as through the opening 5 in the other connection piece 3 or 4, in order to tension a structural element or a stack of structural elements between the respective other connection piece 3 or 4 and an anchor element fastened to the tension element, and to selectively release the same by controlling the contraction elements 8 so as to shorten their lengths 15 between the connection pieces.

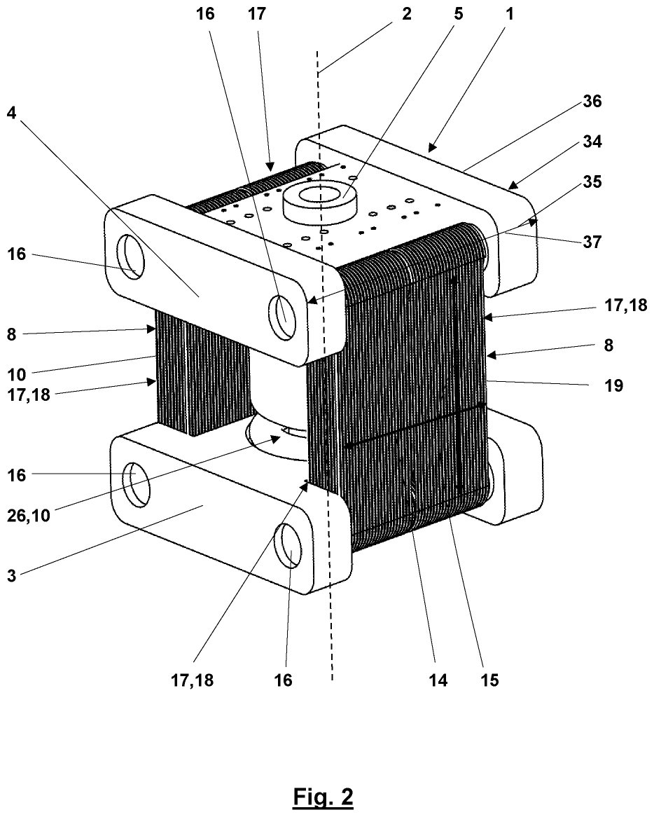

This possible application also exists in the case of the actuator 1 illustrated in the following figures. FIG. 2 shows that the connection pieces 3 and 4 of this actuator 1 are each H-shaped within their rectangular outlines 34, wherein deflection bodies 16 are mounted in the free ends of their limbs. Wires 17 made of the shape memory alloy 18 of the contraction elements 8 extend around the deflection bodies 16. Each of the total of four wires 17 here is wound in a plurality of windings around the respective two deflection bodies 16 on corresponding sides of the connection pieces 3 and 4, wherein length sections 19 of the wire 17 made of the shape memory alloy 18 extend between the connection pieces 3 and 4 and are thereby distributed over the width 14 of the respective contraction element 8. Accordingly, each of the four wires 17 according to FIG. 2 comprises a plurality of successive length sections 19. The width 14 of the contraction elements 8 is here likewise approximately as large as their free length 15 between the connection pieces, this being here the free length of the length sections 19 between the deflection bodies 16. At the same time, the width 14 here amounts to approximately two thirds of the side length 37 of the sides 35 of the outlines 34, which here are somewhat longer than the other sides 36.

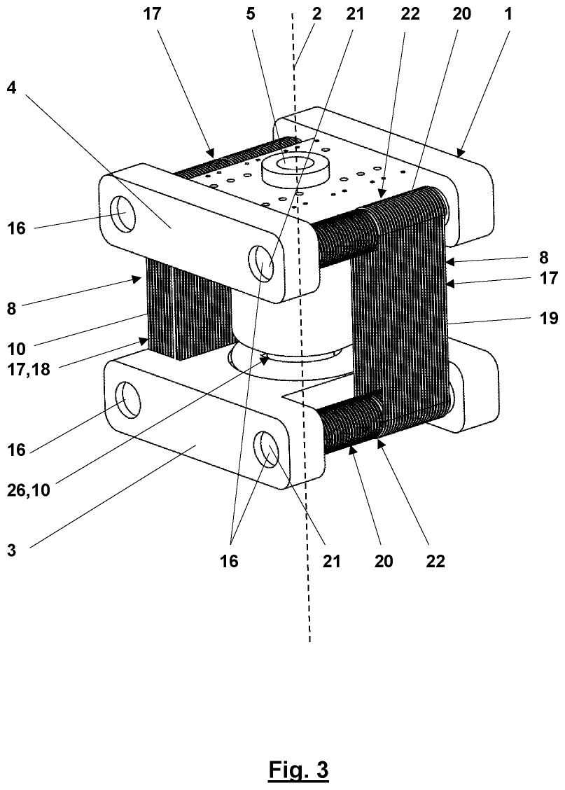

FIG. 3, in which one of the wires 17 is omitted, shows that the deflection bodies 16 each comprise an insulation body 20 which is guided on a bolt 21 and is provided at its outer circumference with grooves 22. The grooves 22 guide the windings of the respective wire 17, so that the individual length sections 19 thereof extend at defined lateral spacings from one another. For direct resistive heating of the wire 17, in which the length sections 19 are connected in series, the wire 17 can be used without additional insulation because the length sections 19 do not enter into electrical contact with one another except via their ends and thus do not electrically short-circuit any part of the respective wire 17.

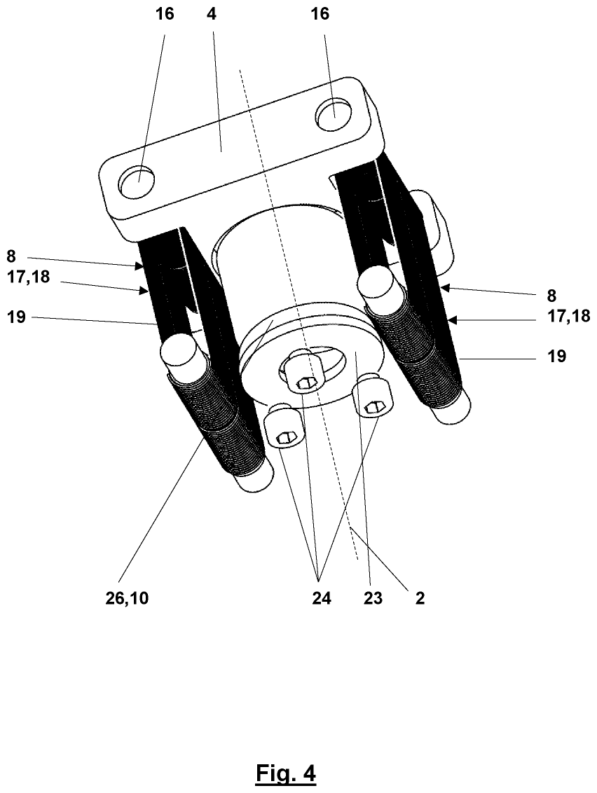

FIG. 4 shows, by omission of the connection piece 3 of the actuator 1 according to FIGS. 3 and 4 and from another viewing angle, an abutment 38 for the compression spring 10, which is formed by free ends of three adjusting screws 24 and the relative position of which with respect to the connection piece 3 omitted in FIG. 4 is adjustable by rotating the three adjusting screws 24 arranged rotationally symmetrically around the actuator main axis 2. The adjustability permits both a displacement of the abutment 38 in the direction of the actuator main axis 2 and an angular alignment of the abutment 38 relative to the actuator main axis 2.

Specifically, the adjusting screws 24 engage into internal threads in a perforated disc 23, which is supported in the direction of the actuator main axis 2 on the connection piece 3 not illustrated here.

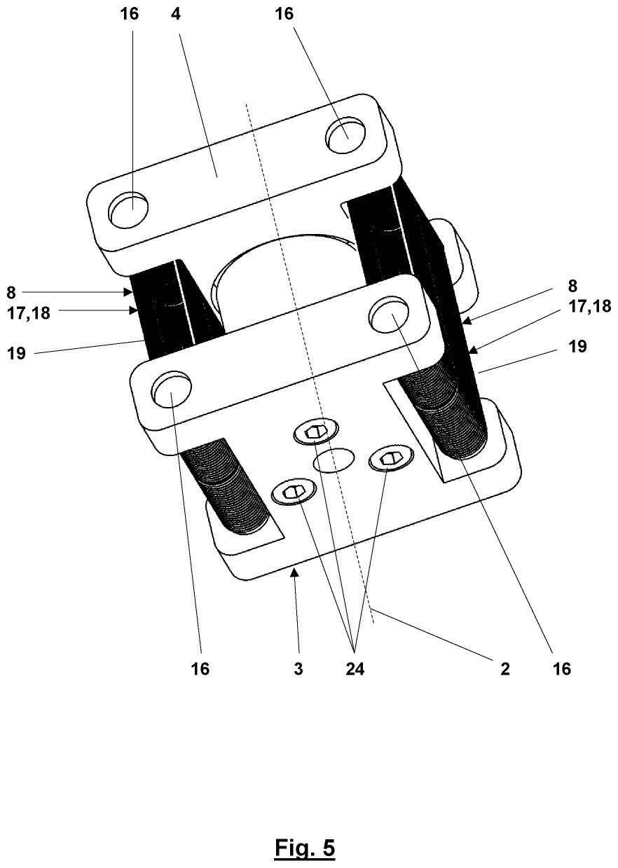

FIG. 5 shows the actuator 1 with the lower connection piece 3 from a viewing direction similar to that in FIG. 4. The heads of the adjusting screws 24 with their tool engagement surfaces are accessible through holes in the connection piece 3. By rotating the adjusting screws 24, not only can the preload of the compression spring 10 be varied, but the compression spring 10 can also be relieved to such an extent that it can be replaced without further disassembly of the actuator 1.

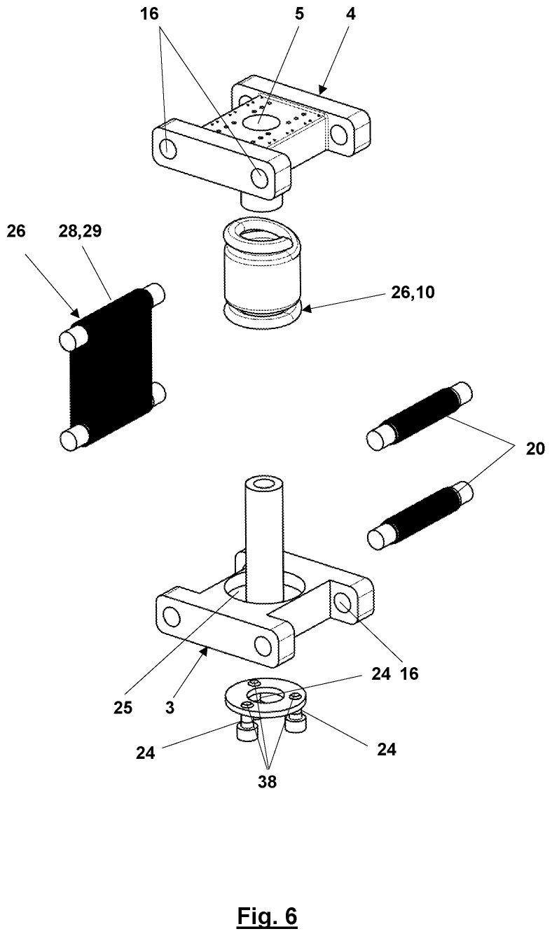

The exploded view according to FIG. 6 shows a ring channel 25 in the lower connection piece 3, in which the compression spring 10 supported on the free ends of the adjusting screws 24 is laterally guided. Furthermore, FIG. 6 shows that the connection pieces 3 and 4 comprise tubular extensions which telescopically engage one another within the compression spring 10 and the lumens of which are aligned with the opening 5.

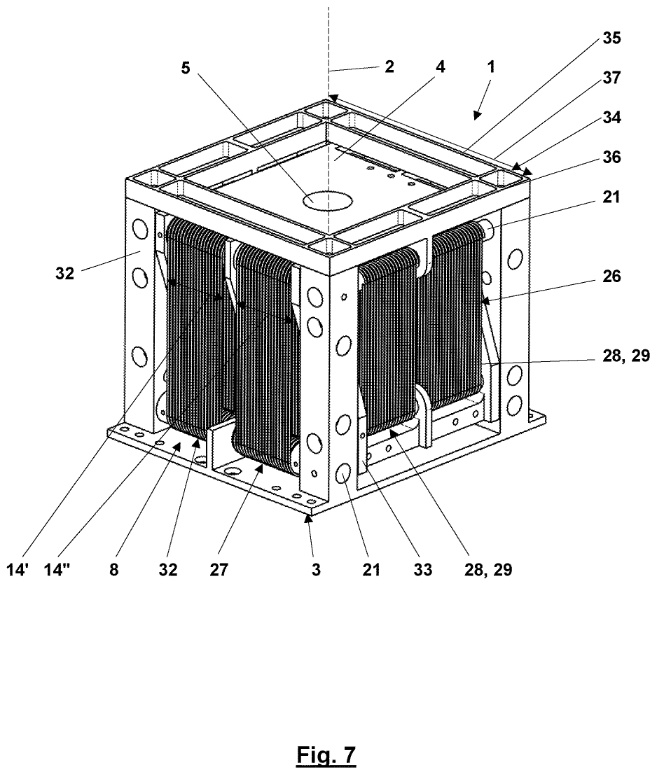

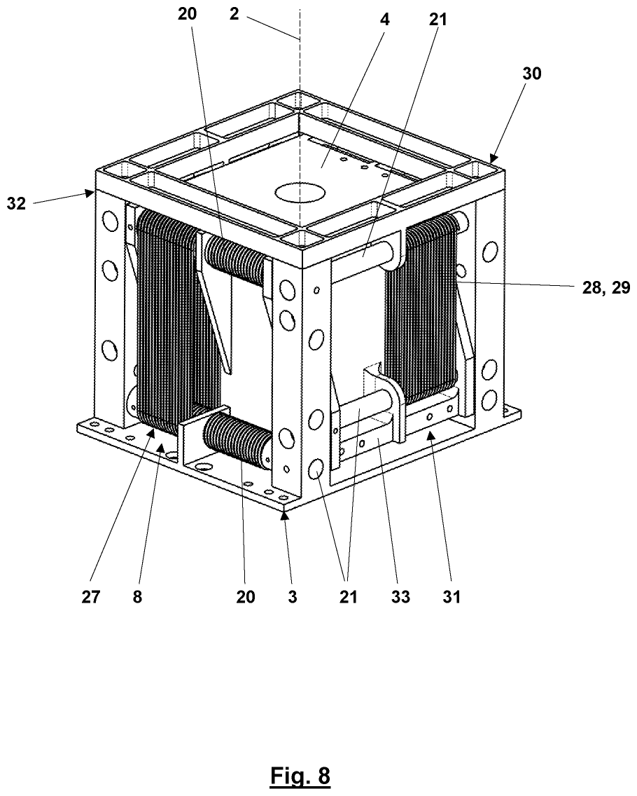

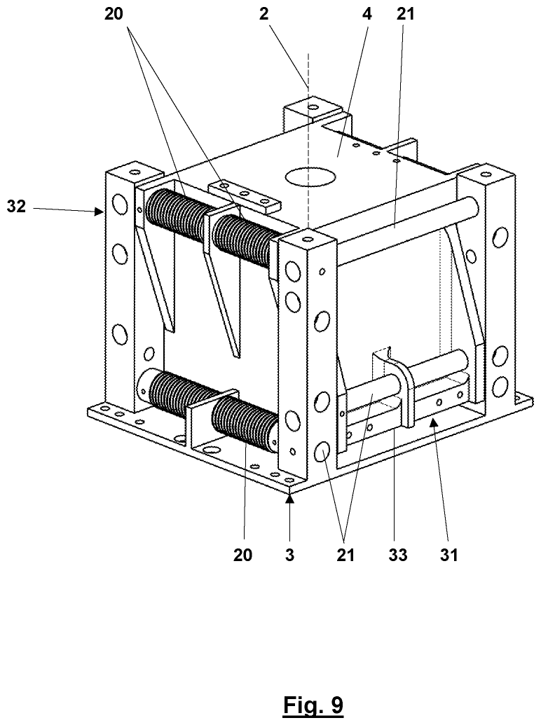

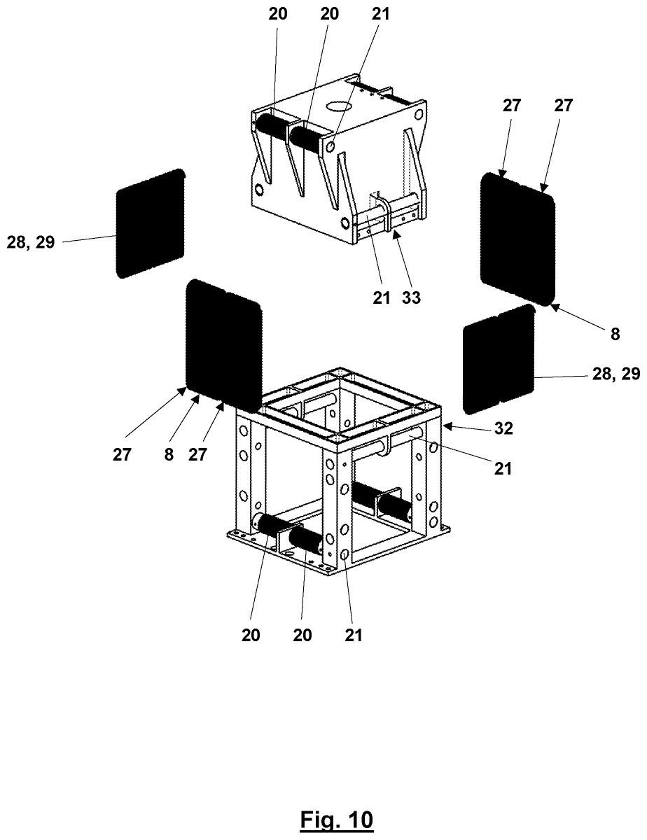

In the embodiment of the actuator 1 illustrated in FIGS. 7 to 10, the two contraction elements 8 are each subdivided into two partial contraction elements 27 which are arranged adjacent to one another in the direction of the width of the respective contraction element 8. In this case, partial widths 14′ and 14″ of the partial contraction elements 27 add up to the width 14 of the contraction elements 8. Due to the subdivision of the contraction elements 8, it is also possible to support the bolts 21, on which the insulation bodies 20 are guided, between the partial contraction elements 27. Furthermore, cantilevers 32 and 33 are attached to both connection pieces 3 and 4 here. Even taking into account the cantilevers 32 and 33, the widths 14 of the contraction elements 8 here are greater than 50% of the side lengths 37 of the sides 35 of the outlines 34 of the connection pieces 3 and 4. The cantilevers 32 and 33 extend and overlap along the actuator main axis 2, so that further connection pieces 30 and 31 at the free ends of the cantilevers 32 and 33 have, along the actuator main axis 2, an order reversed in comparison with the connection pieces 3 and 4 rigidly connected thereto. Between the further connection pieces 30 and 31 extend sections of a tension wire 28 made of a superelastic shape memory alloy 29. The tension wire 28 is wound directly around bolts 21 which are each supported on the further connection pieces 30 and 31 not only at their ends but also at their centers. The tension wire 28 is preloaded to such an extent that it is in a superelastic state and thereby applies a preload force which is largely independent of the spacing of the connection pieces 3 and 4 or of the further connection pieces 30 and 31, that is to say substantially constant. The preload arrangement 26 of this embodiment of the actuator 1 thereby overall applies a comparatively small preload force between the connection pieces 3 and 4 which is at the same time uniformly distributed over the sides 36 of the further connection pieces 30 and 31.

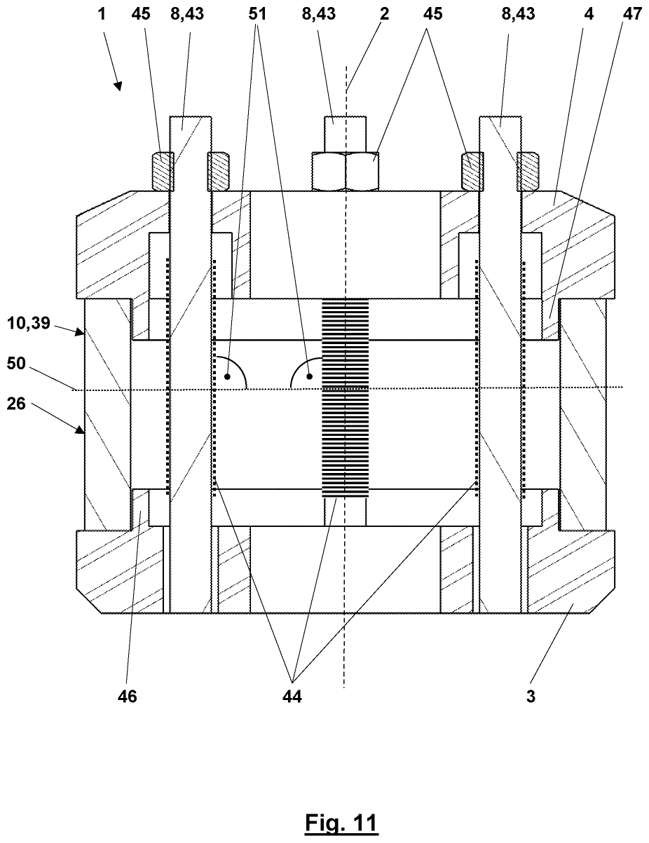

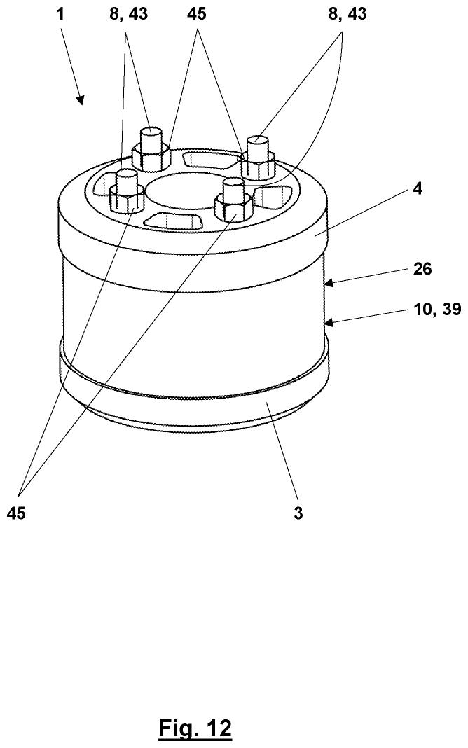

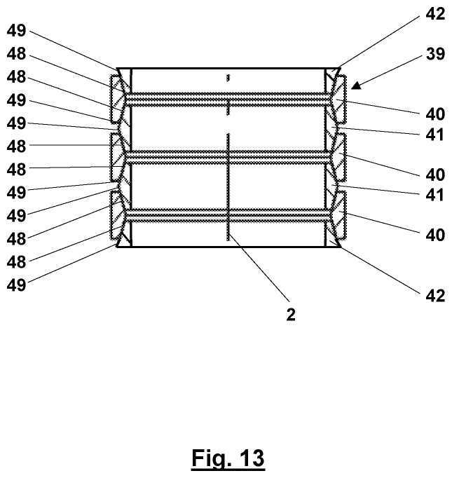

In the other actuator 1 according to the present disclosure illustrated in FIGS. 11 and 12, the connection pieces 3 and 4 are circular-disc-shaped and have a diameter which is only slightly greater than an outer diameter of the compression spring 10 of the preload arrangement 26 which presses the connection pieces 3 and 4 apart. The compression spring 10 is a friction spring 39, although the internal structure thereof is not illustrated in FIGS. 11 and 12. FIG. 13, however, shows that the friction spring 39 is made with outer ring elements 40 and with inner ring elements 41 and 42 engaging into one another and supported against one another via conical surfaces 48 of the outer ring elements 40 and complementary conical surfaces 49 of the outer ring elements 41 and 42. The contraction elements 8 are arranged in the interior of the cylindrical-shell-shaped compression spring 10 and are bolt-shaped contraction elements 43. The bolt-shaped contraction elements extend at right angles 51 relative to a virtual reference plane 50 to which the virtual actuator main axis 2 is a surface normal. The bolt-shaped contraction elements 43 are screwed into the lower connection piece 3 and are supported on the upper side of the upper connection piece 4 via screwed-on tension nuts 8. Between the connection pieces 3 and 4, the bolt-shaped contraction elements 43 are provided with a heating wire winding 44. Annular projections 46 and 47 of the connection pieces 3 and 4 serve for radial guidance of the cylindrical-shell-shaped compression spring 10.

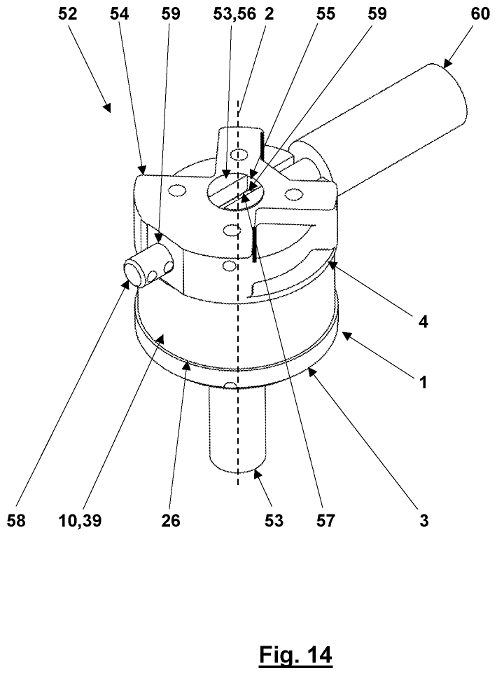

FIG. 14 is a perspective view of a device 52 for holding and releasing a bolt 53 extending coaxially to the actuator main axis 2 of the actuator 1 according to FIGS. 11 to 13, which is a part of the device 52. The device 52 includes a head 54 in which a socket 55 is formed for receiving and securing an upper end section 56 of the bolt 53 comprising an open key hole 57. The head 54 is one part with the upper connection piece 4 of the actuator 1. The lower connection piece 3 of the actuator 1 is supported at a flange (not visible) of the bolt 53. Thus, the preload force forcing the connection pieces 3 and 4 apart tends to pull the upper end section 56 out of the socket 55. However, a securing pin 58 extending through the key hole 57 and two aligned through holes 59 in the head 54 secures the bolt in the socket 55, and the preload force forcing the connection pieces 3 and 4 apart clamps the upper end section 56 on the securing pin 58 in the socket 55 so as to fix the securing pin 59 in the key hole 57. When operating the bolt-shaped contraction elements arranged within the cylindrical-shell-section-shaped friction spring 39 so that they shorten their free lengths between the two connection pieces 3 and 4, the upper end section 56 of the bolt 53 is no longer clamped on the securing pin in the socket 55, and a pin puller 60 can pull back the securing pin 59 out of the key hole 57. In this way, the bolt 53 is released from the socket 55. The upper end section 56 of the bolt 53 is actively pulled out of the socket 55 once the bolt-shaped contraction elements cool down and are forced back to their original length by the preload force forcing the connection pieces 3 and 4 apart.

Many variations and modifications may be made to the preferred embodiments of the invention without departing substantially from the spirit and principles of the invention. All such modifications and variations are intended to be included herein within the scope of the present invention, as defined by the following claims.

I claim:

1. An actuator comprising
a virtual actuator main axis,
two connection pieces spaced apart from one another in the direction of the actuator main axis,
a preload arrangement applying a preload force to the two connection pieces, the preload force pressing the two connection pieces apart in the direction of the actuator main axis, the preload arrangement comprising a friction spring, the friction spring comprising inner ring elements and outer ring elements engaging into one another and supported against one another via complementary conical surfaces of the inner ring elements and the outer ring elements, and
bolt-shaped contraction elements made of a shape memory alloy and supported at the two connection pieces,
wherein the bolt-shaped contraction elements extend over free lengths between the two connection pieces,
wherein, between the two connection pieces, the bolt-shaped contraction elements extend through the inner ring elements and the outer ring elements of the friction spring,
wherein, between the two connection pieces, the bolt-shaped contraction elements are wrapped with at least one of heating wires, heating strips or heating foils, and
wherein the bolt-shaped contraction elements, upon increasing their temperature with the at least one of heating wires, heating strips or heating foils, shorten their free lengths between the two connection pieces.

2. The actuator of claim 1, wherein the bolt-shaped contraction elements are arranged around the actuator main axis.

3. The actuator of claim 2, wherein an arrangement of the bolt-shaped contraction elements is at least one of axisymmetrical or rotationally symmetrical relative to the actuator main axis.

4. The actuator of claim 1, wherein, between the connection pieces, the bolt-shaped contraction elements extend at equal angles relative to a virtual reference plane to which the actuator main axis is a surface normal.

5. The actuator of claim 1, wherein the bolt-shaped contraction elements extend at right angles relative to a virtual reference plane to which the actuator main axis is a surface normal.

6. The actuator of claim 1, wherein, between the two connection pieces, the bolt-shaped contraction elements extend within the friction spring.

7. The actuator of claim 1, wherein the bolt-shaped contraction elements are screwed into one of the two connection pieces and supported on a back side of the other of the two connection pieces via screwed-on tension nuts.

8. The actuator of claim 1, wherein a number of the bolt-shaped contraction elements is four.

9. The actuator of claim 1, further comprising a socket for receiving a section of a bolt, wherein one of the two connection pieces clamps the section of the bolt in the socket with the preload force pressing the two connection pieces apart in the direction of the actuator main axis, and wherein the bolt is released from the socket, when the bolt-shaped contraction elements, upon increasing their temperature with the at least one of heating wires, heating strips or heating foils, shorten their free lengths between the two connection pieces.

10. An actuator comprising
two connection pieces spaced apart from one another in the direction of an actuator main axis,
a preload arrangement applying a preload force to the two connection pieces, the preload force pressing the two connection pieces apart in the direction of the actuator main axis, the preload arrangement comprising a cylindrical-shell-section-shaped friction spring, and
bolt-shaped contraction elements made of a shape memory alloy and supported at the two connection pieces,
wherein the bolt-shaped contraction elements extend over free lengths between the two connection pieces,
wherein, between the two connection pieces, the bolt-shaped contraction elements extend within the cylindrical-shell-section-shaped friction spring,
wherein, between the two connection pieces, the bolt-shaped contraction elements are wrapped with at least one of heating wires, heating strips or heating foils, and
wherein the bolt-shaped contraction elements, upon increasing their temperature with the at least one of heating wires, heating strips or heating foils, shorten their free lengths between the two connection pieces.

11. The actuator of claim 10, wherein the cylindrical-shell-section-shaped friction spring comprises inner ring elements and outer ring elements engaging into one another and supported against one another via complementary conical surfaces of the inner ring elements and the outer ring elements.

12. The actuator of claim 10, wherein the bolt-shaped contraction elements are arranged around the actuator main axis.

13. The actuator of claim 12, wherein an arrangement of the bolt-shaped contraction elements is at least one of axisymmetrical or rotationally symmetrical relative to the actuator main axis.

14. The actuator of claim 10, wherein, between the connection pieces, the bolt-shaped contraction elements extend at equal angles relative to a virtual reference plane to which the actuator main axis is a surface normal.

15. The actuator of claim 10, wherein the bolt-shaped contraction elements extend at right angles relative to a virtual reference plane to which the actuator main axis is a surface normal.

16. The actuator of claim 10, wherein, between the two connection pieces, the bolt-shaped contraction elements extend within the friction spring.

17. The actuator of claim 10, wherein the bolt-shaped contraction elements are screwed into one of the two connection pieces and supported on a back side of the other of the two connection pieces via screwed-on tension nuts.

18. The actuator of claim 10, wherein a number of the bolt-shaped contraction elements is four.

19. The actuator of claim 10, further comprising a socket for receiving a section of a bolt, wherein one of the two connection pieces clamps the section of the bolt in the socket with the preload force pressing the two connection pieces apart in the direction of the actuator main axis, and wherein the bolt is released from the socket, when the bolt-shaped contraction elements, upon increasing their temperature with the at least one of heating wires, heating strips or heating foils, shorten their free lengths between the two connection pieces.

20. A device for holding and releasing a bolt, comprising
a socket for receiving a section of the bolt, and
an actuator comprising
a virtual actuator main axis,
two connection pieces spaced apart from one another in the direction of the actuator main axis,
a preload arrangement applying a preload force to the two connection pieces, the preload force pressing the two connection pieces apart in the direction of the actuator main axis, the preload arrangement comprising a friction spring, the friction spring comprising inner ring elements and outer ring elements engaging into one another and supported against one another via complementary conical surfaces of the inner ring elements and the outer ring elements, and
bolt-shaped contraction elements made of a shape memory alloy and supported at the two connection pieces,
wherein the bolt-shaped contraction elements extend over free lengths between the two connection pieces,
wherein, between the two connection pieces, the bolt-shaped contraction elements extend through the inner rings and the outer rings of the friction spring,
wherein, between the two connection pieces, the bolt-shaped contraction elements are wrapped with at least one of heating wires, heating strips or heating foils, and
wherein the bolt-shaped contraction elements, upon increasing their temperature with the at least one of heating wires, heating strips or heating foils, shorten their free lengths between the two connection pieces,
wherein the actuator is arranged such that the bolt is secured in the socket by the preload force applied to the two connection pieces and released of releasable from the socket, when the temperature of the bolt-shaped contraction elements is increased with the at least one of heating wires, heating strips or heating foils so as to shorten their free lengths between the two connection pieces.
